(19) United States
(12) Patent Application Publication
(10) Pub. No.: US 2023/0341053 A1
(43) Pub. Date: Oct. 26, 2023

(54) BARREL-SHAPED SEAL ELEMENT

(71) Applicant: SERDAR PLASTiK SANAYi VE TiCARET A.S., Ankara (TR)

(72) Inventor: Mustafa Serdar TÜTEK, Ankara (TR)

(73) Assignee: SERDAR PLASTiK SANAYi VE TiCARET A.S., Ankara (TR)

(21) Appl. No.: 18/044,383

(22) PCT Filed: Sep. 10, 2021
(86) PCT No.: PCT/TR2021/050923

§ 371 Date: Mar. 8, 2023

(30) Foreign Application Priority Data
Sep. 11, 2020 (TR) 2020/14445

(51) Int. Cl. F16J 15/10

(52) U.S. Cl. CPC F16J 15/106; F16J 15/108; F16J 15/328

(57) ABSTRACT

The subject of the present invention relates to a sealing gasket that has a section formed like a barrel, that does not have mold joint line, ejector marks, burrs, offset and runner entry marks for perfect sealing, that can be easily molded and can be removed from the mold without a core in order to be used in all required areas where sealing is required and the application surfaces are suitable for the structure of the gasket.

### BACKGROUND OF THE INVENTION

The present invention relates to a sealing gasket that is formed in order to be used in all required areas, whose application areas are suitable for the structure of the gasket where sealing is required, that does not have a mold joint line, ejector marks, burrs, offset and runner entry marks for perfect sealing, that can be easily molded and can be removed from the mold without a core.

It is characterized by that there are no injection points, ejector marks, mold joint burrs, and offset on the sealing surface of the gasket.

### TECHNICAL FIELD OF THE INVENTION

The present invention relates to a sealing gasket, which is formed in order to be used in all required areas where sealing is required and where the application surfaces are suitable for the structure of the gasket, which does not have injection points, ejector marks, mold joint burrs and offset on the sealing surface for the perfect sealing.

### PRIOR ART

In the state of the art, sealing is provided by means of using an additional sealing element (oring, gasket, etc.) that is generally used in all required sealing areas. However, elements such as mold joint line, runner entry mark, joint edge mark, burrs, and offset on the sealing surfaces of these sealing elements cause some sealing problems thereby creating weakness and deformation problems in said portions.

In addition, since these sealing elements do not provide integrity with the part to which they are attached the sealing is ensured by being compressed between two hard plastics. Over time, these sealing elements lose their properties due to the pressure in the working environment, and a gap between the plastics is formed due to the effect of the pressure and thereby, causing sealing problems.

### BRIEF STATEMENT OF THE INVENTION

The subject of the present invention relates to a sealing gasket that has a section formed like a barrel, that does not have mold joint line, ejector marks, burrs, offset and runner entry marks for perfect sealing, that can be easily molded and can be removed from the mold without a core in order to be used in all required areas where sealing is required and the application surfaces are suitable for the structure of the gasket.

In the molds of plastic parts, if there are figures perpendicular to the mold separating line, these are called undercuts. The mold elements that are operated with various movements in order to mold the undercuts in the mold are called cores. The subject of the present invention, on the other hand, relates to the sealing gasket that can be removed from the mold without a core.

It is characterized by that there are no mold joint line, ejector marks, burrs, offset and runner entry marks on the gasket sealing surface.

This structure aims to prevent sealing problems by means of providing smooth and perfect sealing on the sealing surface.

### DETAILED DESCRIPTION OF THE INVENTION

The subject of the present invention relates to a sealing gasket that has a section formed like a barrel, that does not have mold joint line, ejector marks, burrs, offset and runner entry marks for perfect sealing, that can be easily molded in order to be used in all required areas where sealing is required and where the application surfaces are suitable for the structure of the gasket. The sealing gasket has a structure that is resistant to high temperatures and that does not lose the form in which it is polymerized and molded. It has high impact resistance and is extremely flexible. The sealing gasket with barrel section can be resistant to high temperatures without the loss of shape and mechanical properties thereof. It is characterized by that it does not have mold joint line on the sealed gasket for perfect sealing, and this property thereof ensures that there are no elements that cause weakness and deformation problems in these portions over time, such as mold joint line, ejector marks, burrs, offset and runner entry marks on sealing surface, and that perfectly prevent sealing problems on the sealing surfaces. With the barrel-shaped sectional structure thereof, the lower and upper joint surfaces have a flat structure, and the sealing surfaces have an outward cambered structure. The lower and upper surfaces of the gasket completely coincide with the corresponding surfaces of the parts when the parts in the sealing areas are closed reciprocally, and the side surfaces that do not have mold joint lines, runner entry, and burrs on the cambered sealing surface flex and joint on the walls in this closed portion, thereby providing maximum sealing at four points.

### BRIEF DESCRIPTION OF THE FIGURES

FIG. 1 illustrates the Sealing Gasket Section.

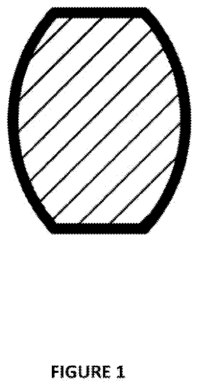

FIG. 2 illustrates the Sealing Gasket, Sealing Areas.

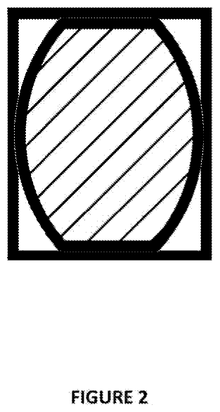

FIG. 3 illustrates the Sealing Gasket, Detail of Gasket Sealing.

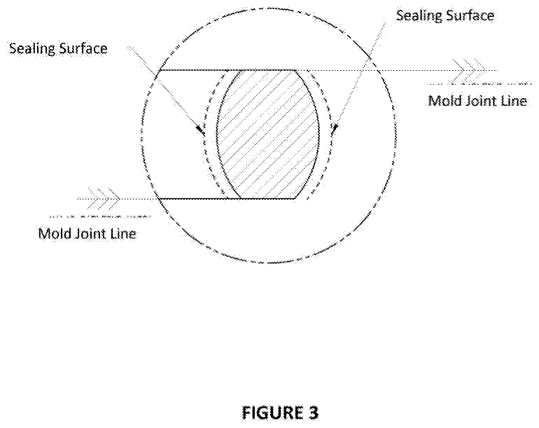

### REFERENCE NUMERALS IN FIGURES

1—Sealing Surface
2—Mold Joint Line

The runner entry mark is generally located on the sealing surfaces of the gaskets used, therefore, problems such as deformation, weakness, cracking, tearing, and offset occur in these joining portions over time. It is characterized by that there are no runner entry marks and mold joint marks on the sealing surfaces in said sealing gasket. This feature thereof ensures that sealing surfaces are not deteriorated under no circumstances during production, and a perfect sealing is achieved by means of providing the runner entry from the flat surfaces of the gasket with barrel-shaped section at the lower and upper points thereof.

There may be a dislocation or bending when the corresponding surfaces of the gaskets generally used are compressed in the phase of reciprocally joining the parts that require sealing, however, the aforementioned sealing gasket with barrel-shaped section that provides a complete joint on the corresponding surfaces of the parts with barrel-shaped structure thereof completely joints to the surfaces of the parts instead of compressing in an uncontrolled manner, and flexes from the cambered parts and covers all surfaces completely.

It can be easily grouped where it is attached and it does not fall by means of the flexible structure thereof, it provides a complete joint between four surfaces by stretching instead of compressing between two surfaces. As described in detail, it provides a better sealing by means of providing complete joint on the sealing surfaces with the barrel-shaped section thereof and the structure of the sealing surface that does not have a mold joint line, ejector marks, burrs and offset. Thus, it is aimed to prevent sealing problems throughout its physical life.

What is claimed is:

1. A sealing gasket characterized in that, it is barrel-shaped in order to provide complete sealing and that the sealing surfaces on the sides are not deteriorated under any circumstances by means of providing runner entry from the flat surfaces of the gasket at the lower and upper points thereof during the production phase.

2. A sealing gasket characterized in that, it has long physical life since it does not have mold joint line, ejector marks, mold joint burrs, and offset on the sealing surfaces thereof.

3. A sealing gasket according to claim 1, characterized in that, it is a sealing gasket that does not have injection points, mold joint line, ejector marks, mold joint burrs, and offset for perfect sealing, and that can be easily molded and can be removed from the mold without a core.

4. A sealing gasket according to claim 1, characterized in that, it has a structure that is resistant to high temperatures and that does not lose the form in which it is polymerized and molded. It has high impact resistance and is extremely flexible. It is characterized by being a sealing gasket that can be resistant to high temperatures without the loss of shape and mechanical properties thereof.

5. A sealing gasket according to claim 1, characterized in that, the gasket with barrel-shaped section completely joint to the corresponding surfaces of the parts to be joined by means of that the lower and upper surfaces thereof are being flat, and provides maximum sealing at four points by flexing on the walls in this closed portion with its side surfaces that does not have injection point, ejector marks, mold joint burrs, and offset.
